(19) United States
(12) Patent Application Publication
(10) Pub. No.: US 2025/0087798 A1
(43) Pub. Date: Mar. 13, 2025

(54) Power Battery Top Cover, Battery and Electrical Device

(71) Applicant: JIANGSU ZENERGY BATTERY TECHNOLOGIES CO., LTD., Suzhou, Jiangsu (CN)

(72) Inventors: Zhikang WU, Suzhou, Jiangsu (CN); Yongjun LI, Suzhou, Jiangsu (CN); Shengli CHEN, Suzhou, Jiangsu (CN); Bin JIANG, Suzhou, Jiangsu (CN); Wuyuan ZOU, Suzhou, Jiangsu (CN)

(21) Appl. No.: 18/576,101

(22) PCT Filed: Jun. 24, 2022
(86) PCT No.: PCT/CN2022/101064

§ 371 Date: Jan. 3, 2024

(30) Foreign Application Priority Data
Jul. 15, 2021 (CN) 202121607574.7

(51) Int. Cl. H01M 50/169; H01M 50/188; H01M 50/30; H01M 50/528; H01M 50/531; H01M 50/588; H01M 50/627

(52) U.S. Cl. CPC H01M 50/169; H01M 50/188; H01M 50/30; H01M 50/528; H01M 50/531; H01M 50/588; H01M 50/627

(57) ABSTRACT

The disclosure provides a power battery top cover, a battery and an electrical device. The power battery top cover includes: a top cover plate, and a first electrode terminal assembly and a second electrode terminal assembly are mounted on the top cover plate; the first electrode terminal assembly includes an electrode member and a connecting piece, wherein the electrode member is formed by protruding upward from the top cover plate; and the connecting piece includes a body portion and a connecting portion, the connecting portion is provided at an end portion of the body portion, a recess is provided at the bottom of the top cover plate, and at least a part of the connecting portion is embedded in the recess. In the disclosure, the insulation fitting and the air-tightness fitting are omitted, thereby facilitating reduction of the production cost of the top cover.

### CROSS-REFERENCE TO RELATED APPLICATION

This application is a National Stage Filing of the PCT International Application No. PCT/CN2022/101064 filed on Jun. 24, 2022, which claims priority to Chinese Patent Application No. 202121607574.7 filed to the China National Intellectual Property Administration on Jul. 15, 2021 and entitled “Power Battery Top Cover, Battery and Electrical Device”.

### TECHNICAL FIELD

The disclosure belongs to the technical field of battery production and manufacturing, and in particular, to a power battery top cover, a battery and an electrical device.

### BACKGROUND

Nowadays, a lithium ion battery, as a novel secondary battery, has advantages of high energy density and power density, high working voltage, light weight, small volume, long cycle life, good safety, and being environmentally friendly, and has a wide application prospect in aspects such as portable electronic appliances, electric tools, large energy storage, and electric mobility power sources. In order to electrically connect an internal electrode to an external circuit, a lithium battery generally needs to provide a positive electrode terminal and a negative electrode terminal on a top cover. Currently, the positive electrode terminal and the negative electrode terminal are usually configured to be not in direct conduction with a top cover plate, but are indirectly fixed to the top cover plate by an insulation member, an first plastic member and a second plastic member, so as to prevent the positive electrode terminal and the negative electrode terminal from being short-circuited by the top cover. Due to the requirement of air tightness, it is necessary to provide a sealing ring between the electrode terminals and the top cover plate to prevent air leakage.

In an existing top cover structure, at least one set of an first plastic member, a second plastic member and a sealing ring are required for each of the positive electrode terminal and the negative electrode terminal, respectively; however, the material cost is high; in addition, processes such as riveting and welding are also required to fix the positive electrode terminal and the negative electrode terminal to the top cover plate respectively, resulting in high manufacturing costs.

### SUMMARY

One object of the disclosure is to provide a power battery top cover regarding the shortcomings of the related art, in which the insulation fitting and the air-tightness fitting are omitted, thereby facilitating reduction of the production cost of a top cover.

In order to achieve the object above, the disclosure adopts the following technical solutions:

A power battery top cover, including: a top cover plate, and a first electrode terminal assembly and a second electrode terminal assembly are mounted on the top cover plate; the first electrode terminal assembly includes an electrode member and a connecting piece, wherein the electrode member is formed by protruding upward from the top cover plate, and the connecting piece is connected to the top cover plate; and the connecting piece includes a body portion and a connecting portion, the connecting portion is provided at an end portion of the body portion, a recess is provided at the bottom of the top cover plate, and at least a part of the connecting portion is embedded in the recess.

In an embodiment mode, the body portion includes a first segment and a second segment; the first segment is connected to the connecting portion, the first segment is parallel to the second segment, and a bending segment is provided between the first segment and the second segment.

In an embodiment mode, the body portion and the connecting portion are of an integrated structure, and the first segment is perpendicular to the bottom surface of the connecting portion.

In an embodiment mode, the first segment extends downwards from an edge of the connecting portion.

In an embodiment mode, the recess is L-shaped, square-shaped, circular or oval.

In an embodiment mode, the top cover plate is provided with an electrode terminal through hole, and the second electrode terminal assembly includes an electrode terminal body, an first plastic member, a sealing ring and a second plastic member; the electrode terminal body passes through the electrode terminal through hole, the first plastic member, the sealing ring and the second plastic member are sequentially sleeved on the electrode terminal body from top to bottom, and a welding member is mounted at the bottom of the electrode terminal body.

In an embodiment mode, the top cover plate is provided with at least one of an explosion-proof valve hole and a liquid injection hole.

A second object of the disclosure is to provide a battery, including the power battery top cover above.

A third object of the disclosure is to provide an electrical device, including the power battery top cover above.

The beneficial effects of the disclosure lie in that: In an existing top cover structure, at least one set of an first plastic member, a second plastic member and a sealing ring are required for each of the positive electrode terminal and the negative electrode terminal, respectively; however, the material cost is high; in addition, processes such as riveting and welding are also required to fix the positive electrode terminal and the negative electrode terminal to the top cover plate respectively, resulting in high manufacturing costs. Therefore, the electrode member is formed by protruding upward from the top cover plate, reserving of an electrode terminal through hole of the first electrode terminal assembly on the top cover plate is omitted, the insulation fitting or the air-tightness fitting do not need to be mounted, thereby being not limited by the sealing performance of the insulation fitting or the air-tightness fitting, facilitating improvement of the sealing performance of the battery; and the number of fittings of the top cover are reduced, facilitating reduction of the manufacturing cost of the whole top cover. Moreover, the connecting portion of the connecting piece is partially embedded in the recess at the bottom of the top cover plate, and the recess not only functions to limit the position of the connecting portion, but also functions to increase the contact area between the connecting piece and the top cover plate, which facilitates improvement of the stability between the top cover plate and the connecting piece and facilitates welding of the connecting piece into the recess, thereby facilitating reduction of the welding difficulty of the connecting piece, and reducing the production cost of the top cover; wherein the body portion extends downwards from the middle or a side portion of the connecting portion and is welded together with a plurality of tabs of a cell; the connecting portion of the connecting piece is welded in the recess, the connecting piece is detached from or mounted to the bottom of the top cover plate; and according to the size of a battery, only the connecting piece needs to be replaced separately, and replacement of the corresponding insulation fitting or the air-tightness fitting is omitted, thereby facilitating reduction of the maintenance and production costs of the top cover of the battery. In the disclosure, the insulation fitting and the air-tightness fitting are omitted, thereby facilitating reduction of the production cost of the top cover.

### BRIEF DESCRIPTION OF THE DRAWINGS

Features, advantages, and technical effects of exemplary embodiments of the disclosure will be described below with reference to the accompanying drawings.

FIG. 1 is a schematic structural diagram of a top cover plate of Embodiment I of the disclosure.

FIG. 2 is a schematic structural diagram after the top cover plate is connected to a connecting piece of Embodiment I of the disclosure.

FIG. 3 is a side view after the top cover plate is connected to a connecting piece of Embodiment I of the disclosure.

FIG. 4 is a schematic structural diagram after a second electrode terminal assembly is connected of Embodiment II of the disclosure.

FIG. 5 is a front view after a second electrode terminal assembly is connected of Embodiment II of the disclosure.

FIG. 6 is a schematic structural diagram after the top cover plate is connected to a connecting piece of Embodiment IV of the disclosure.

FIG. 7 is a schematic structural diagram after a second electrode terminal assembly is connected of Embodiment IV of the disclosure.

The reference signs are illustrated as follows:

1—Top cover plate; 10—Recess; 11—Electrode terminal through hole; 12—Explosion—proof valve hole; 13—Liquid injection hole;

2—Electrode member;

3—Connecting piece; 31—Body portion; 32—Connecting portion; 311—First segment; 312—Second segment; 313—Bending segment; 314—Top surface;

4—Electrode terminal body;

5—First plastic member;

6—Second plastic member;

7—Welding member.

### DETAILED DESCRIPTION OF THE EMBODIMENTS

For example, certain terms are used in the description and claims to refer to specific assemblies. A person skilled in the art would understand that hardware manufacturers may refer to the same assembly by using different nouns. The present description and claims do not use differences in names as a manner for distinguishing assemblies, but use differences in functions of assemblies as a criterion for distinguishing. For example, the term “including” mentioned throughout the description and the claims is an open-ended term and should be interpreted as “including but not limited to”. “Approximately” refers to within an acceptable error range, and a person skilled in the art would have been able to solve the technical problem within a certain error range and substantially achieve the technical effect.

In addition, the terms “first”, “second” and the like are used for descriptive purposes only and cannot be construed as indicating or implying relative importance.

In the disclosure, unless specified or limited otherwise, the terms such as “mount”, “connect to”, “connect” and “fix”, etc. should be understood broadly, and for example, may be fixed connection, and may also be detachable connection, or integral connection; may be mechanical connection, and may also be electrical connection; and may be direct connection, and may also be indirect connection by means of an intermediate medium, and may also be interior communication between two elements. For a person of ordinary skill in the art, the specific meanings of the described terms in the disclosure could be understood according to specific situations.

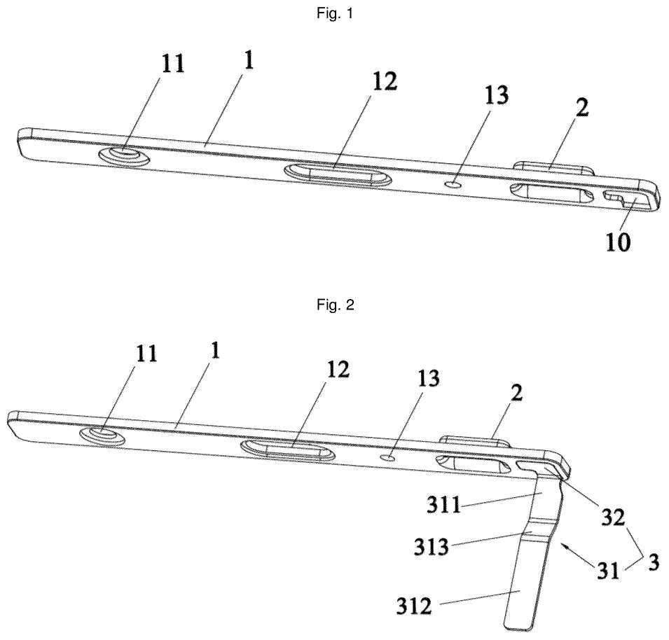

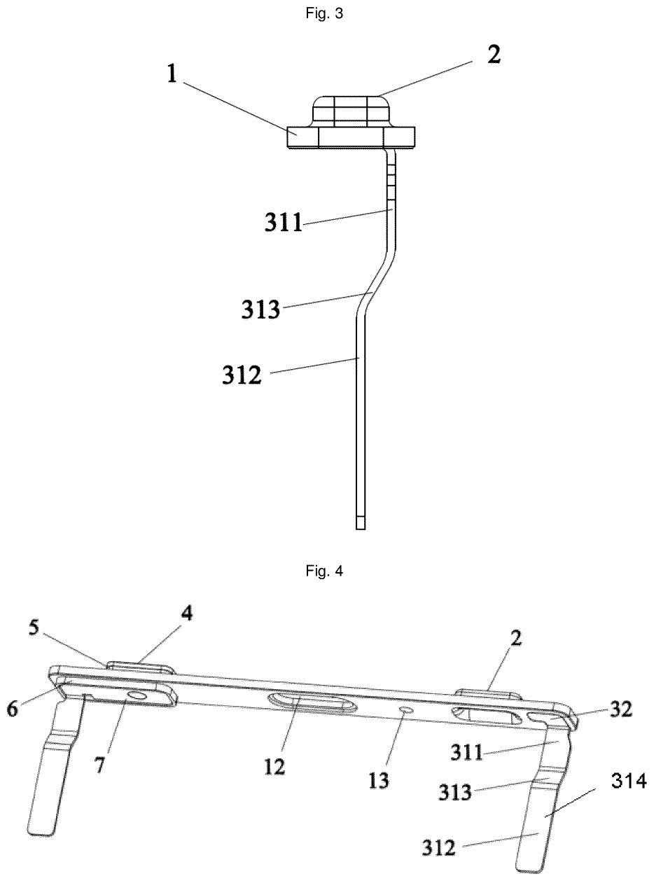

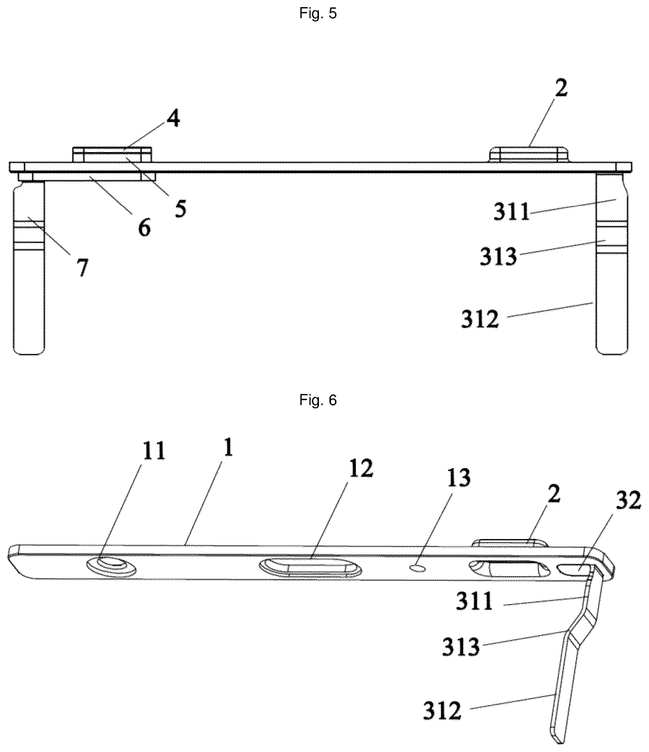

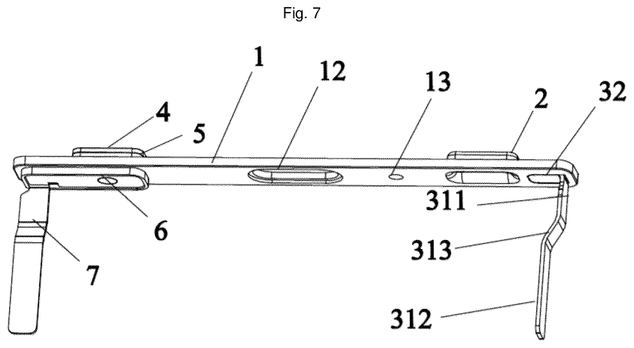

Hereinafter, the disclosure will be further described in detail in conjunction with the FIGS. 1-7, but the illustration does not serve as a definition to the disclosure.

### Embodiment I

Hereinafter, Embodiment I is described in combination with FIGS. 1-3:
a power battery top cover, including a top cover plate 1, and a first electrode terminal assembly and a second electrode terminal assembly are mounted on the top cover plate 1; the first electrode terminal assembly includes an electrode member 2 and a connecting piece 3, wherein the electrode member 2 is formed by protruding upward from the top cover plate 1, and the connecting piece 3 is connected to the top cover plate 1; the connecting piece 3 includes a body portion 31 and a connecting portion 32, the connecting portion 32 is provided at an end portion of the body portion 31, a recess 10 is provided at the bottom of the top cover plate 1, and at least a part of the connecting portion 32 is embedded in the recess 10. In FIG. 1, the top cover plate is provided with at least one of an explosion-proof valve hole 12 and a liquid injection hole 13.

In an existing top cover structure, at least one set of an first plastic member, a second plastic member and a sealing ring are required for each of the positive electrode terminal and the negative electrode terminal, respectively; however, the material cost is high; in addition, processes such as riveting and welding are also required to fix the positive electrode terminal and the negative electrode terminal to the top cover plate respectively, resulting in high manufacturing costs. Therefore, the electrode member 2 is formed by protruding upward from the top cover plate 1, reserving of an electrode terminal through hole 11 of the first electrode terminal assembly on the top cover plate 1 is omitted, insulation fitting or the air-tightness fitting do not need to be mounted, thereby being not limited by the sealing performance of the insulation fitting or the air-tightness fitting, facilitating improvement of the sealing performance of the battery; and the number of fittings of the top cover are reduced, facilitating reduction of the manufacturing cost of the whole top cover. Moreover, the connecting portion 32 of the connecting piece 3 is partially embedded in the recess 10 at the bottom of the top cover plate 1, and the recess 10 not only functions to limit the position of the connecting portion 32, but also functions to increase the contact area between the connecting piece 3 and the top cover plate 1, which facilitates improvement of the stability between the top cover plate 1 and the connecting piece 3 and facilitates welding of the connecting piece 3 into the recess 10, thereby facilitating reduction of the welding difficulty of the connecting piece 3, and reducing the production cost of the top cover; wherein the body portion 31 extends downwards from the middle or a side portion of the connecting portion 32 and is welded together with a plurality of tabs of a cell; the connecting portion 32 of the connecting piece 3 is welded in the recess 10, the connecting piece 3 is detached from or mounted to the bottom of the top cover plate 1; and according to the size of a battery, only the connecting piece 3 needs to be replaced separately, and replacement of the corresponding insulation fitting or the air-tightness fitting is omitted, thereby facilitating reduction of the maintenance and production costs of the top cover of the battery.

In the present embodiment, the electrode member 2 is formed by protruding upward from the top cover plate 1 to form a raised bump structure, a raised block structure or other protrusion structures, but the disclosure is not limited thereto; the height of the protrusion is adjusted according to the actual structure of a battery; in another embodiment, the electrode member 2 is a planar structure, i.e. being flush with the surface of the top cover plate 1, which helps to reduce the overall height of the top cover plate 1. In addition, the recess 10 is internally provided with a protrusion, and the surface of the connecting portion 32 is provided with a recess matching the protrusion, so that the connecting portion 32 and the recess 10 match each other in a matching manner.

The first electrode terminal assembly is a positive electrode terminal assembly, the second electrode terminal assembly is a negative electrode terminal assembly, and the negative electrode terminal assembly uses an insulation fitting and a air-tightness fitting, while the positive electrode terminal assembly adopts a structure of the electrode member 2 and the connecting piece 3, thereby omitting the insulation fitting and the air-tightness fitting of the positive electrode terminal assembly, reducing the production cost of the top cover. However, the disclosure is not limited thereto, the first electrode terminal assembly is a negative electrode terminal assembly, and the second electrode terminal assembly is a positive electrode terminal assembly, as long as insulation between the positive electrode terminal assembly and the negative electrode terminal assembly is satisfied.

In the power battery top cover according to the disclosure, the body portion 31 includes a first segment 311 and a second segment 312; the first segment 311 is connected to the connecting portion 32, the first segment 311 is parallel to the second segment 312, and a bending segment 313 is provided between the first segment 311 and the second segment 312. By adding the bending segment 313, the shape of the body portion 31 matches the shape of the plurality of tabs of a cell, so as to reduce risks such as lithium plating occurring in the cell. Specifically, the bending segment 313 is an inclined portion connecting the first segment 311 and the second segment 312, and a circular-arc smooth transition is formed between the bending segment 313 and the first segment 311 and between the bending segment 313 and the second segment 312, so as to avoid damage to the plurality of tabs at the bending position. The first segment 311 is parallel to the second segment 312. in another embodiment, the two segments are not parallel, and the length of the second segment 312 is greater than or equal to the length of the first segment 311.

In the power battery top cover according to the disclosure, the body portion 31 and the connecting portion 32 are of an integrated structure, and the first segment 311 is perpendicular to the bottom surface of the connecting portion 32. In this embodiment, the body portion 31 and the connecting portion 32 use an integrally-formed structure, which facilitates improving the mechanical strength of the connecting piece 3, and also reducing the production cost of the connecting piece 3. Specifically, the connecting piece 3 is formed by stamping the same plate, and is integrally formed by an aluminum casting process, the body portion 31 and the connecting portion 32 are both plate-shaped structures, and the size of the body portion 31 is slightly larger than that of the connecting portion 32, which helps to increase the contact area between the connecting piece 3 and the plurality of tabs of the cell, increasing the current passing area, reducing the heating amount inside the battery, and also connecting the body portion 31 to more cells, thereby facilitating improving the energy density of the battery. In addition, the thickness of the connecting portion 32 is the same as the depth of the recess 10, and the size of the recess 10 is slightly larger than the size of the connecting portion 32, so that the whole connecting portion 32 is accommodated in the recess 10, and welding is performed along a gap between the connecting portion 32 and the recess 10 during welding. The thickness direction of the body portion 31 is parallel to the width direction of the top cover plate 1, that is, a top surface 314 of the body portion 31 is perpendicular to the side wall of the plurality of tabs of the cell, so as to facilitate bending or welding the plurality of tabs of the cell.

In the power battery top cover according to the disclosure, the first segment 311 extends downwards from an edge of the connecting portion 32; however, the disclosure is not limited thereto; the position where the first segment 311 extends downwards is adjusted according to the actual position of the cell, and the first segment is extend downwards from the middle of the connecting portion 32, as long as the body portion 31 and the plurality of tabs of the cell are welded together.

### Embodiment II

This embodiment differs from Embodiment I in that: the top cover plate 1 of the present embodiment is provided with an electrode terminal through hole 11, and the second electrode terminal assembly includes an electrode terminal body 4, an first plastic member 5, a sealing ring and a second plastic member 6; the electrode terminal body 4 passes through the electrode terminal through hole 11, the first plastic member 5, the sealing ring and the second plastic member 6 are sequentially sleeved on the electrode terminal body 4 from top to bottom, and a welding member 7 is mounted at the bottom of the electrode terminal body 4. Specifically, the first plastic member 5 is sleeved on the electrode terminal body 4, and the sealing ring is provided between the first plastic member 5 and the top cover plate 1, so that the electrode terminal body 4 is fastened on the top cover plate 1, which not only achieves an insulation effect between the top cover plate 1 and the electrode terminal body 4, but also ensures the tightness between the top cover plate 1 and the electrode terminal body 4. The bottom of the electrode terminal body 4 passes through the electrode terminal through hole 11 of the top cover plate 1, and the welding member 7 is fixed at the bottom of the electrode terminal body 4, which is able to improve the stability between the electrode terminal body 4 and the welding member 7, prevent the welding member 7 from falling off, and facilitate improvement of the safety of the battery. Moreover, a part of the electrode terminal body 4 is fixed on the bottom surface of the top cover plate 1 by the second plastic member 6, the second plastic member 6 achieves the effect of insulating the electrode terminal body 4 from the bottom surface of the top cover plate 1, and the electrode terminal body 4 is fixed on the top cover plate 1, which helps to improve the stability between the electrode terminal body 4 and the top cover plate 1. The sealing ring is an assembly part formed by injection molding of fluoroplastics or die cutting of fluoroplastics, and has good electrical insulation performance, high heat resistance, oil resistance, solvent resistance, wear resistance, humidity resistance and low temperature resistance, which facilitates prolonging the service life of the sealing ring, thereby improving the safety performance of the cell; wherein the welding member 7 is welded together with the plurality of tabs of the cell, and achieves the effect of electrically connecting the electrode terminal body 4 to the plurality of tabs.

Other structures are the same as those in the Embodiment I, and will not be repeated herein.

### Embodiment III

This embodiment differs from Embodiment I in that: in the present embodiment, the recess 10 is L-shaped, square-shaped, circular or oval, the shape of the connecting portion 32 matches the shape of the recess 10, and both the corners of the top cover plate 1 and the corners of the connecting piece 3 are of rounded corner structures. In the present embodiment, the recess 10 is L-shaped, and the connecting portion 32 is also L-shaped; however, the disclosure is not limited thereto, and the recess 10 is of regular shapes such as a square, a circle, or an oval, or other irregular shapes; wherein the corners of the connecting portion 32, the corners of the body portion 31 and the corners of the top cover plate 1 all adopt rounded corner structures, so as to avoid damage to the cell when the battery is assembled, which helps to improve the safety of the battery.

Other structures are the same as those in the Embodiment I, and will not be repeated herein.

### Embodiment IV

This embodiment differs from Embodiment I in that: in the present embodiment, the thickness direction of the body portion 31 of the connecting piece 3 is perpendicular to the width direction of the top cover plate 1, that is, the top surface 314 of the body portion 31 faces towards the side wall of the plurality of tabs of the cell, and the top surface 314 of the body portion 31 is parallel to the side wall of the plurality of tabs of the cell, which also facilitates bending or welding the plurality of tabs of the cell. According to the actual structure of the plurality of plurality of tabs of the battery, the orientation of the top surface 314 of the body portion 31 is adjusted, so as to achieve a better welding effect.

Other structures are the same as those in the Embodiment I, and will not be repeated herein.

### Battery and Electrical Device

A battery, including the power battery top cover of Embodiments I-IV.

It should be noted that the battery includes a housing and a top cover plate 1; the housing includes an accommodation space enclosed by a plurality of side walls and an opening formed at one side of the accommodation space. The top cover plate 1 is provided at the opening to seal the accommodation space. The top cover plate 1 is provided with a first electrode terminal assembly and a second electrode terminal assembly, wherein the first electrode terminal assembly and the second electrode terminal assembly serve as an external conduction end of the battery, and the first electrode terminal assembly and the second electrode terminal assembly are used for being electrically connected to other components. The same battery has two electrode pole assemblies, i.e. one positive electrode terminal assembly and one negative electrode terminal assembly.

The battery further includes an electrode assembly, wherein the electrode assembly includes a body unit and a plurality of tabs, the body unit and the plurality of tabs are connected to each other.

The body unit may have a winding structure or a lamination structure. The body unit includes a positive electrode plate, a negative electrode plate, and a separator. Specifically, the separator is made of PP, PE or the like. The positive electrode plate includes a positive current collector and a positive active material layer, wherein the positive active material layer is coated on the surface of the positive current collector, the material of the positive current collector is aluminium, and the positive active material is lithium cobalt oxide, lithium iron phosphate, ternary lithium, lithium manganate, etc.; and the negative electrode plate includes a negative current collector and a negative active material layer, wherein the negative active material layer is coated on the surface of the negative current collector, the material of the negative current collector is copper, and the negative active material is carbon or silicon, etc.

A plurality of tabs are used for being electrically connected to the first electrode terminal assembly and the second electrode terminal assembly so as to lead electric energy of the first electrode terminal assembly and the second electrode terminal assembly to the outside of the battery. The plurality of tabs are generally arranged on the positive electrode plate and the negative electrode plate in the body unit, and the plurality of tabs generally include a plurality of positive tabs and a plurality of negative tabs. In order to ensure that the plurality of tabs may pass a large current without fusion, the plurality of positive tabs are provided and laminated together, and the plurality of negative tabs are also provided and laminated together. It is understood that the plurality of tabs are directly connected to the first electrode terminal assembly and the second electrode terminal assembly; and the plurality of tabs are indirectly connected to the first electrode terminal assembly and the second electrode terminal assembly.

An electrical device, including the power battery top cover of Embodiment I-III.

It should be noted that the electrical device is a vehicle, a mobile phone, a portable device, a laptop, a ship, a spacecraft, an electric toy, an electric tool, and the like. The vehicle is a fuel vehicle, a gas vehicle or a new energy vehicle, and the new energy vehicle is a pure electric vehicle, a hybrid electric vehicle or an extended-range vehicle, etc.; the spacecraft includes an aircraft, a rocket, a space shuttle and a spaceship, etc.; the electric toy includes a stationary or mobile electric toy, such as a game machine, an electric vehicle toy, an electric ship toy, and an electric plane toy; and the electric tool includes a metal cutting electric tool, a grinding electric tool, an assembling electric tool and a railway electric tool, for example, an electric drill, an electric sander, an electric spanner, an electric screwdriver, an electric hammer, an electric hammer drill, a concrete vibrator and an electric planer, and the disclosure does not specifically limit the described electrical device.

According to the disclosure and teaching of the description above, a person skilled in the field to which the disclosure belongs would also have been able to make changes and modifications to the embodiments above. Therefore, the disclosure is not limited to the described specific embodiments, and any obvious improvements, replacements or modifications made by a person skilled in the art on the basis of the disclosure shall all belong to the scope of protection of the disclosure. In addition, although some specific terms are used in the present description, these terms are merely used for convenience of illustration and do not constitute any limitation on the disclosure.

What is claimed is:

1. A power battery top cover, comprising:
a top cover plate, and a first electrode terminal assembly and a second electrode terminal assembly are mounted on the top cover plate;
the first electrode terminal assembly comprises an electrode member and a connecting piece, wherein the electrode member is formed by protruding upward from the top cover plate, and the connecting piece is connected to the top cover plate; and
the connecting piece comprises a body portion and a connecting portion, the connecting portion is provided at an end portion of the body portion, a recess is provided at the bottom of the top cover plate, and at least a part of the connecting portion is embedded in the recess.

2. The power battery top cover according to claim 1, wherein the body portion comprises a first segment and a second segment;
the first segment is connected to the connecting portion, the first segment is parallel to the second segment, and a bending segment is provided between the first segment and the second segment.

3. The power battery top cover according to claim 2, wherein the body portion and the connecting portion are of an integrated structure, and the first segment is perpendicular to the bottom surface of the connecting portion.

4. The power battery top cover according to claim 3, wherein the first segment extends downwards from an edge of the connecting portion.

5. The power battery top cover according to claim 1, wherein the recess is L-shaped, square-shaped, circular or oval.

6. The power battery top cover according to claim 1, wherein the top cover plate is provided with an electrode terminal through hole, and the second electrode terminal assembly comprises an electrode terminal body, an first plastic member, a sealing ring and a second plastic member; the electrode terminal body passes through the electrode terminal through hole, the first plastic member, the sealing ring and the second plastic member are sequentially sleeved on the electrode terminal body from top to bottom, and a welding member is mounted at the bottom of the electrode terminal body.

7. The power battery top cover according to claim 1, wherein the top cover plate is provided with at least one of an explosion-proof valve hole and a liquid injection hole.

8. A battery, comprising the power battery top cover according to claim 1.

9. An electrical device, comprising the power battery top cover according to claim 1.

10. The power battery top cover according to claim 2, wherein the length of the second segment is greater than or equal to the length of the first segment.

11. The power battery top cover according to claim 1, wherein the recess is provided with a protrusion, and a surface of the connecting portion is provided with another recess matching the protrusion.

12. The power battery top cover according to claim 1, wherein the thickness direction of the body portion of the connecting piece is perpendicular to the width direction of the top cover plate.

13. The battery according to claim 8, wherein the body portion comprises a first segment and a second segment;
the first segment is connected to the connecting portion, the first segment is parallel to the second segment, and a bending segment is provided between the first segment and the second segment.

14. The battery according to claim 13, wherein the body portion and the connecting portion are of an integrated structure, and the first segment is perpendicular to the bottom surface of the connecting portion.

15. The battery according to claim 14, wherein the first segment extends downwards from an edge of the connecting portion.

16. The battery according to claim 13, wherein the length of the second segment is greater than or equal to the length of the first segment.

17. The battery according to claim 8, wherein the top cover plate is provided with an electrode terminal through hole, and the second electrode terminal assembly comprises an electrode terminal body, an first plastic member, a sealing ring and a second plastic member; the electrode terminal body passes through the electrode terminal through hole, the first plastic member, the sealing ring and the second plastic member are sequentially sleeved on the electrode terminal body from top to bottom, and a welding member is mounted at the bottom of the electrode terminal body.

18. The battery according to claim 8, wherein the top cover plate is provided with at least one of an explosion-proof valve hole and a liquid injection hole.

19. The battery according to claim 8, wherein the recess is provided with a protrusion, and a surface of the connecting portion is provided with another recess matching the protrusion.

20. The battery according to claim 8, wherein the thickness direction of the body portion of the connecting piece is perpendicular to the width direction of the top cover plate.
